(19) United States
(12) Patent Application Publication
(10) Pub. No.: US 2020/0187602 A1
(43) Pub. Date: Jun. 18, 2020

(54) SEALING STRIP, BUCKLE ASSEMBLY AND CLAMP

(71) Applicant: LANGFANG ALKEM MATERIAL TECHNOLOGY CO., LTD., LANGFANG (CN)

(72) Inventor: Enhua QIU, LANGFANG (CN)

(73) Assignee: LANGFANG ALKEM MATERIAL TECHNOLOGY CO., LTD.

(21) Appl. No.: 16/798,427

(22) Filed: Feb. 23, 2020

Related U.S. Application Data
(63) Continuation of application No. PCT/CN2017/112616, filed on Nov. 23, 2017.

(30) Foreign Application Priority Data
Aug. 24, 2017 (CN) 201710734654.0

(51) Int. Cl. A44B 11/10; F16J 15/02; F16J 15/06; F16L 59/02; F16L 59/12

(52) U.S. Cl. CPC A44B 11/10; F16J 15/027; F16L 59/123; F16L 59/02; F16J 15/061

(57) ABSTRACT

The present invention belongs to the technical field of isolation sealing, and particularly discloses a sealing strip, which includes a strip-shaped thermal insulating layer and a supporting core rod. Clamps are arranged on the supporting core rod; and the supporting core rod is matched and connected with the strip-shaped thermal insulating layer. According to the sealing strip provided by the present invention, the supporting core rod in the sealing strip provides rigidity for the sealing strip, so that the sealing strip has rigidity, the number of the used clamps is reduced, and automatic mounting can be achieved. The clamps are connected with the sealing strip through the supporting core rod, so that the structure of the strip-shaped thermal insulating layer of the sealing strip is not destroyed, and the sealing and thermal insulating effect is ensured.

### CROSS-REFERENCE TO RELATED APPLICATIONS

This application is a continuation of International Patent Application No. PCT/CN2017/112616 with a filing date of Nov. 23, 2017, designating the United States, now pending, and further claims priority to Chinese Patent Application No. 201710734654.0 with a filing date of Aug. 24, 2017. The content of the aforementioned applications, including any intervening amendments thereto, are incorporated herein by reference.

### TECHNICAL FIELD

The present invention belongs to the technical field of isolation and sealing, relates to a sealing strip mounted on a box body, and also relates to a clamp and a buckle assembly for mounting the sealing strip and other similar members to mounting positions.

### BACKGROUND OF THE PRESENT INVENTION

Tubular sealing strips are mounted at open ends of box bodies of heating, refrigeration or thermal insulation equipment such as ovens, refrigerators and microwave ovens. However, since the box bodies of the equipment are all composed of a housing and an inner container, direct contact between the inner container and the housing and direct contact between a box door and the box body are generally avoided to ensure the thermal insulating effect, thereby preventing heat conduction. Therefore, when the inner container is connected with the housing, the inner container needs to be fixed in the housing by several fixing points. As shown in FIG. 1, a lowest-temperature region will be selected for welding the inner container 3′ and the housing 2′. Some welding points 4′ are located at an outermost part of the inner container 3′ and are arranged along the circumference of the front of the box body. Since a plurality of welding points 4′ are arranged in a slot 1′ between the inner container 3′ and the housing 2′, fixing parts of the sealing strip will be blocked at the points in the prior art, and the whole sealing strip cannot be pushed into the slot 1′.

Chinese patent CN201620824102.X provides a solution. The patent discloses a sealing strip and an electrical appliance with the sealing strip, wherein the sealing strip includes an inner supporting tube and a protective sleeve; and a buckle is mounted on the sealing strip. It is recorded in the specification of the patent that the buckle is disclosed in the prior art; as shown in drawings of the specification, the buckle is as disclosed in a Chinese patent having an application number of 201110231176.4 and an application title of “Steel Wire Hook”; the buckle is composed of a single elastic metal wire, including a head part and a bottom part; the head part and the bottom part are connected together, planes, on which the head part and the bottom part are located, are perpendicular to each other; the head part is provided with a top part with a circular arc and symmetrical left shoulder and right shoulder formed by extending metal wires downwards; a lower end of the head part of the buckle is provided with a short pin forming an angle with the bottom part; the short pin is tilted towards a direction of the top part; the bottom part is approximately elliptical and is wound by the metal wire in a horizontal direction; the bottom part is provided with a long pin bent inwards; and a large gap is formed between the long pin and a main body of the bottom part, so that the buckle can be conveniently screwed into the sealing strip. In order to match the fixing of such a buckle, a plurality of fixing holes need to be punched at inner edges of the housing or outer edges of the inner container of the box body as fixing positions of the buckle. The sealing strip having the buckle is mounted as follows: the head part and a tail part are found and stretched at first; then each buckle is aligned with positions of corresponding fixing holes in the box body; four corners of the box body corresponding to the sealing strip are fixed by the buckles; and then each buckle is sequentially stuffed into the corresponding fixing hole to complete mounting.

The mode for mounting the buckle and the sealing strip has the following disadvantages:
(1) when the bottom part of the buckle is screwed into the interior of the sealing strip, the bottom part of the buckle is easy to scratch the protective sleeve of the sealing strip, thereby causing failure of thermal insulating effect in the inner container,
(2) the mounting of the sealing strip has many operation steps and complicated operation; moreover, one hand needs to hold the sealing strip and the other hand needs to hold the buckle during the whole mounting process, causing that the hands are easy to be stabbed by the tilted short pin of the buckle during the mounting process;
(3) since the fixing hole is formed in the inner edges of the housing or the outer edge of the inner container, a center line of the sealing strip will always offset from the center line of the slot after the sealing strip is fixed by the buckle, thereby reducing the thermal insulating effect and increasing energy consumption of equipment;
(4) the sealing strip having the buckle with the above structure can only be mounted by manpower and does not have mechanical automatic mounting conditions, thereby causing low mounting efficiency and high labor cost.

### SUMMARY OF PRESENT INVENTION

The present invention mainly solves a technical problem of providing a sealing strip which has rigidity and can realize automatic mounting. When the sealing strip is mounted on a box body, a center line of the sealing strip and the center line of a slot between an inner container and a housing of the box body can be ensured to be located on the same plane, so that the sealing strip can completely seal the slot to ensure the sealing effect. Meanwhile, the present invention also provides a clamp for solving the problem that a structure of a buckle is punctured during operation in the prior art. The present invention also provides a buckle assembly, which cannot damage the thermal insulating layer of the sealing strip when being mounted on the sealing strip, thereby ensuring the effect of the sealing strip.

To solve the above technical problem, the sealing strip of the present invention adopts a technical solution that the sealing strip includes a strip-shaped thermal insulating layer, wherein the strip-shaped thermal insulating layer is matched and connected with a supporting core rod; and clamps are assembled on the supporting core rod.

Further preferably, the strip-shaped thermal insulating layer is arranged into a hollow structure; the supporting core rod includes an internal part located inside the hollow interior of the strip-shaped thermal insulating layer and external parts penetrating through an outer peripheral surface of the strip-shaped thermal insulating layer at intervals; and the clamps are connected to the external parts of the supporting core rod.

Further preferably, a front end and a tail end of the supporting core rod are further connected with each other, so that the supporting core rod forms a closed annular structure; and the front end and the tail end of the strip-shaped thermal insulating layer are further connected with each other, so that the strip-shaped thermal insulating layer forms an annular structure corresponding to the annular structure of the supporting core rod.

Further preferably, the sealing strip further includes an elastic supporting net which is attached to an inner wall of a hollow inner cavity of the strip-shaped thermal insulating layer; or the elastic supporting net is embedded in a solid structure of the strip-shaped thermal insulating layer.

Further preferably, each clamp includes a connecting part and a clamping part extending from the connecting part; each clamping part includes oppositely arranged elastic compressing pieces; and the connecting parts are matched and connected with the supporting core rod.

Further preferably, an accommodating groove is formed in each connecting part; the accommodating groove is a closing-in groove; the elastic compressing pieces are connected with an open end of the accommodating groove; and the supporting core rod is arranged in the accommodating groove.

Further preferably, the elastic compressing pieces are arranged into a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

Further preferably, the outer peripheral surface of the connecting part is further arranged into a circular arc surface.

Further preferably, the accommodating groove is further arranged into an arc-shaped groove.

The buckle assembly of the present invention adopts a technical solution that the buckle assembly includes a supporting core rod assembled on a sealing member and a clamp assembled on the supporting core rod, wherein the clamp includes a connecting part and a clamping part extending from the connecting part; the connecting part is matched and connected with the supporting core rod; and the clamping part includes oppositely arranged elastic compressing pieces.

Further preferably, an accommodating groove is formed in the connecting part; the accommodating groove is a closing-in groove; the elastic compressing pieces are connected with an open end of the accommodating groove; and the supporting core rod is arranged in the accommodating groove.

Further preferably, the elastic compressing pieces are of a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

Further preferably, the outer peripheral surface of the connecting part is further arranged into a circular arc surface.

The clamp of the present invention adopts a technical solution that the clamp includes a connecting part and a clamping part extending from the connecting part, wherein the clamping part includes oppositely arranged elastic compressing pieces; an accommodating groove is formed in the connecting part; the accommodating groove is a closing-in groove; the elastic compressing pieces are connected with an open end of the accommodating groove; the elastic compressing pieces are arranged into a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

Further preferably, the outer peripheral surface of the connecting part is further arranged into a circular arc surface.

Further preferably, the accommodating groove is further arranged into an arc-shaped groove.

The present invention has beneficial effects as follows:

For the sealing strip provided by the present invention, the supporting core rod in the sealing strip provides rigidity to the sealing strip, so that the sealing strip has rigidity, and the number of the clamps mounted on the sealing strip is reduced, thereby further simplifying the operation process. Moreover, the sealing strip has rigidity and plasticity, can keep a certain shape, and does not need manual straightening operation; and the sealing strip having the rigidity can realize automatic mounting, thereby reducing labor costs and having high mounting efficiency. The clamps are connected with the sealing strip through the supporting core rod, are clamped into the slot between the inner container and the housing, and can directly avoid the welding positions of the inner container and the housing. Firstly, clamping holes are not formed in the box body, thereby ensuring the stability of the box body and reducing the process costs; and secondly, the center line of the sealing strip can be ensured to be located on the same plane as the center line of the slot, so that the sealing strip is horizontally symmetrical about the slot and completely seals the slot, thereby ensuring the sealing effect. Moreover, when the clamps are stuffed into the slot, the supporting core rod can be pressed onto the slot to completely block the slot, thereby further ensuring the sealing effect.

Further, the strip-shaped thermal insulating layer is arranged into the hollow structure; the supporting core rod is connected with the strip-shaped thermal insulating layer in a manner of penetrating the strip-shaped thermal insulating layer from a hollow interior of the strip-shaped thermal insulating layer at intervals. Firstly, stable connection between the supporting core rod and the strip-shaped thermal insulating layer can be ensured, and no other fixing process is needed for fixing. In addition, the clamps are connected with the external parts of the supporting core rod and further indirectly connected with the strip-shaped thermal insulating layer and the clamps can be fixed outside the strip-shaped thermal insulating layer, so that the strip-shaped thermal insulating layer is not damaged, and the sealing thermal insulating effect is ensured.

Further, the supporting core rod and the strip-shaped thermal insulating layer are connected to form an annular structure; the sealing strip can be directly manufactured according to the dimension of the box body; and the mounting process can be completed only by direct clamping, thereby realizing convenient and simple operation and greatly improving the working efficiency.

Further, the elastic supporting net is arranged so that the sealing strip has certain elasticity, thereby prolonging the service life of the sealing strip.

Further, for the provided clamp, the connecting part and the clamping part are integrally extended; a protruding free end does not exist at a joint of the connecting part and the clamping part, so that the problem that the hand is stabbed in a process of mounting the sealing strip in the prior art does not exist.

Further, the accommodating groove is formed in the connecting part; and the clamps can be tightly and fixedly connected with the supporting core rod through the accommodating groove without adopting other fixing modes, thereby realizing convenient operation, low cost and compact structure while ensuring stable connection.

Further, the elastic compressing pieces are preferably arranged into a plate-like structure, so that the pressing is convenient when pressing manually, and tenderness will not occur after operation for a long time.

Further, the outer peripheral surface of the connecting part is preferably arranged into the circular arc surface, so that the clamps can be more smoothly mounted on the supporting core rod.

For the buckle assembly provided by the present invention, the clamps are fixed by the supporting core rod so that each clamp has a fixed mounting position, the clamps do not need to be screwed into the interior of the sealing strip for connection and do not directly contact and connect with the sealing strip; therefore, the thermal insulating layer of the sealing strip is not damaged, and the effect of the sealing strip is ensured.

For the clamp provided by the present invention, the connecting part and the clamping part are integrally extended; and the protruding free end does not exist at the joint of the connecting part and the clamping part, thereby avoiding the problem that the structure of the buckle is punctured during operation in the prior art.

### DESCRIPTION OF THE DRAWINGS

FIG. 1 is a structural schematic diagram of a box body in the prior art;

FIG. 2 is a structural schematic diagram of an embodiment 1 of a clamp according to the present invention;

FIG. 3 is a structural schematic diagram of an embodiment 2 of a clamp according to the present invention;

FIG. 4 is a structural schematic diagram of an embodiment of a buckle assembly according to the present invention;

FIG. 5 is a structural schematic diagram of an embodiment 1 of a sealing strip according to the present invention;

FIG. 6 is a section view of FIG. 5;

FIG. 7 is a schematic diagram of connection between a front end and a tail end of a strip-shaped thermal insulating layer in an embodiment 1 of a sealing strip according to the present invention;

FIG. 8 is a section view of an embodiment 2 of a sealing strip according to the present invention;

FIG. 9 is a schematic diagram of a mounting state in an embodiment 1 of a sealing strip according to the present invention; and

FIG. 10 is a structural schematic diagram of an example of a mounting fixture when automatic mounting is adopted for an embodiment 1 of a sealing strip according to the present invention.

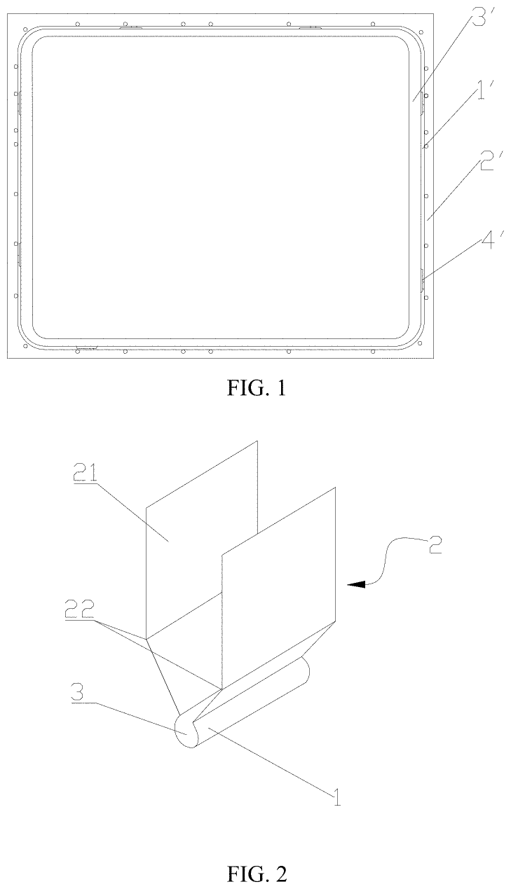

### DETAILED DESCRIPTION OF PREFERRED EMBODIMENTS

In description of specific embodiments of the present invention, it should be understood that azimuths or positional relationships indicated by terms “center”, “longitudinal”, “lateral”, “upper”, “lower”, “front”, “rear”, “left”, “right”, “vertical”, “horizontal”, “top”, “bottom”, “inner”, “outer” and the like are based on the azimuths or positional relationships shown in the accompanying drawings, are only used for facilitating the description of the present invention and simplifying the description, rather than indicating or implying that the indicated device or element must have a specific azimuth or must be constructed and operated in a specific azimuth, and therefore cannot be understood as a limitation of the present invention. In addition, the terms “first”, “second” and the like are intended for description only and cannot be understood as indicating or implying relative importance or implicitly indicating the number of indicated technical features. Therefore, a feature defined with “first”, “second” and the like may explicitly or implicitly include one or more of the features. “A plurality of” means two or more in the description of the present invention, unless otherwise specified. The term “and/or” used in the specification includes any or all combinations of one or more related listed items.

In the description of the present invention, it should be noted that the terms “mount”, “link”, “connect” and the like should be understood in a broad sense unless explicitly stated and defined otherwise. For example, connection may be fixed connection, detachable connection or integral connection; may be mechanical connection or electrical connection; may be direct connection, can also be indirect connection through an intermediate medium, and may be internal communication of two elements. For those ordinary skilled in the art, the specific meaning of the above terms in the present invention can be understood through specific conditions.

To facilitate the understanding of the present invention, the present invention will be described in more detail below with reference to the accompanying drawings and the specific embodiments. Preferred embodiments of the present invention are shown in the accompanying drawings. However, the present invention can be implemented in many different forms and is not limited to the embodiments described in the specification. On the contrary, the embodiments are provided for the purpose of more thorough and complete understanding of contents disclosed by the present invention.

### Embodiment 1 of a Clamp

As shown in FIG. 2, the present embodiment 1 includes a connecting part 1 and a clamping part 2 extending from the connecting part 1. The clamping part 2 includes oppositely arranged elastic compressing pieces 21.

Since the connecting part 1 and the clamping part 2 of the present embodiment are integrally extended, a protruding free end does not exist at a joint of the clamping part 2 and the connecting part 1, so that a risk that the hand is stabbed during manual operation does not exist.

Further, an accommodating groove 3 is formed in the connecting part 1 according to the present embodiment; the accommodating groove 3 is a closing-in groove; and the elastic compressing pieces 21 are connected with an open end of the accommodating groove 3. Thus, the connecting part 1 can be connected with an external member through the accommodating groove 3 in a penetrating and matching manner, when the elastic compressing pieces 21 are pressed relatively, the elastic compressing pieces 21 drive the open end of the accommodating groove 3 to close in, so that a groove wall of the accommodating groove 3 can be tightly held and matched with the external member, thereby preventing the present embodiment from moving on the external member, and further enabling the present embodiment to be stably mounted on the external member.

Certainly, in other embodiments, the connecting part 1 may also be arranged into other structures, such as solid cylinders, and the connecting part having such a structure may be connected to the external member by welding, gluing or other manner, or be in threaded connection with the external member and the like.

The present embodiment is further preferably arranged as follows. The elastic compressing pieces 21 in the present embodiment are arranged into a plate-like structure; and the lengths of the elastic compressing pieces 21 extend along a direction of a center line of the accommodating groove 3. Due to a large operating area, the elastic compressing pieces 21 with the plate-like structure are more convenient to be held and pressed during manual operation, so that the risk of finger pressing pain caused by pressing and holding a buckle with a metal wire structure by fingers for a long time in the prior art does not exist.

Lower halves of the elastic compressing pieces 21 in the present embodiment are gradually and obliquely extended relatively outward from bottom to top to form relatively outwardly expanded clamping shoulders 22; and upper halves of the elastic compressing pieces 21 are vertically extended upward from the clamping shoulders 22 in parallel with each other, so that a compression range between the two elastic compressing pieces 21 is relatively large, which is more suitable for a situation that the precision of the clamping part is not high.

The present embodiment is further preferably arranged as follows. An outer peripheral surface of the connecting part is arranged into a circular are surface, so that the present embodiment is more smoothly mounted on the external member.

Certainly, in other embodiments, to facilitate the connection of the connecting part 1 and the external member, the outer peripheral surface of the connecting part 1 may be arranged into various shapes as required, such as a triangular structure, a square structure and a prismatic structure. The shape of the outer peripheral surface of the connecting part 1 is not limited here.

The present embodiment is further preferably arranged as follows. The accommodating groove 3 is further arranged into an arc-shaped groove, so that the connecting part 1 has a larger holding area and a better holding effect.

Certainly, in other embodiments, for better holding the external member by the accommodating groove 3, the shape of the accommodating groove 3 should be arranged in accordance with the shape of the outer peripheral surface of the external member. Therefore, the shape of the accommodating groove 3 is not limited here.

When the present embodiment is used, for example, the external member is clamped in the slot existing between the inner container and the housing of the box body, wherein the shape of the external member is cylindrical; the present embodiment is firstly mounted on the external member through the connecting part 1; and a mounting method is that the external member is relatively moved to the connecting part 1 in a gap between the elastic compressing pieces 21 of the present embodiment and is accommodated in the accommodating groove 3 of the connecting part 1 so that the present embodiment is mounted on the external member may be adopted. After the present embodiment is mounted, the elastic compressing pieces 21 of the present embodiment is manually pressed to relatively compress the two elastic compressing pieces 21; then, the present embodiment is clamped into the slot that avoids welding positions between the inner container and housing of the box body; the clamping shoulders 22 of the elastic compressing pieces 21 are clamped at end faces of a process folding edge of the inner container and a process folding edge of the housing to complete clamping mounting; and it should be noted herein that the process folding edges refer to folding edges formed in processes of punching and molding the inner container and the housing. The elastic compressing pieces 21 of the present embodiment generates a relatively outward expansion force at this time, so that the clamping shoulders 22 of the elastic compressing pieces 21 can be pressed at the end faces of the process folding edge of the inner container and the process folding edge of the housing, thereby ensuring that the external member will not fall off. Meanwhile, two elastic compressing pieces 21 are relatively compressed to drive the open end of the accommodating groove 3 to gradually close in; and the connecting part 1 tightly holds the external member to avoid the risk that the present embodiment slides on the external member. Therefore, the external member can be stably clamped into the slot between the inner container and the housing of the box body by the present embodiment.

The slot 1′ is formed by combining the inner container 3′ and the box body 2′ and is fixed by welding. Generally, vertical and horizontal width ranges of the slot 1′ are within 3.5+/−1.5 mm, so the width dimension of the slot 1′ will vary, and the elastic compressing pieces 21 in the present embodiment can be compressed to 0 mm from a distance in a relaxed state. A compression space between the elastic compressing pieces 21 can compensate for the variation of the width dimension of the slot, so that the application range of the present embodiment is wider.

### Embodiment 2 of the Clamp

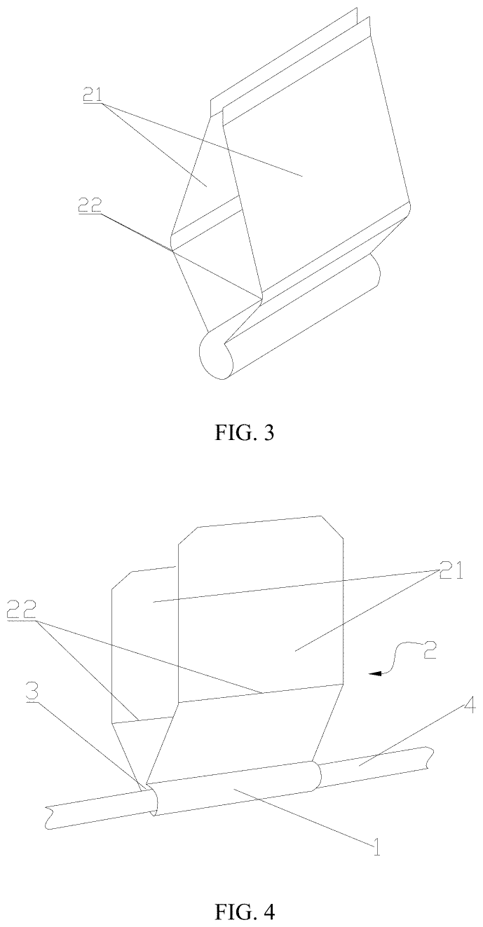

As shown in FIG. 3, the present embodiment is different from the embodiment 1 of the clamp in that extension structures of the upper halves of the elastic compressing pieces 21 are different; and the upper halves of the elastic compressing pieces 21 of the present embodiment are gradually and obliquely closed relatively inwards and upwards from the clamping shoulders 22.

When the present embodiment needs to be clamped into the slot of the box body, ends of the elastic compressing pieces of the present embodiment can be directly aligned with the slot and are inserted into the slot; then, the present embodiment can be directly pushed into the slot; the inner container and the housing respectively apply force to the elastic compressing pieces at this time without applying an external compression force to the elastic compressing pieces, thereby facilitating the operation. Moreover, a free compression space between the upper ends of the two elastic compressing pieces 21 is relatively small; and a relatively large pressure is required when the two elastic compressing pieces are compressed. Therefore, the present embodiment is not easy to fall off when being clamped into the slot; and the present embodiment is more firmly clamped with the slot. Moreover, the present embodiment is more suitable for slots with accurate dimensions.

### Embodiment of a Buckle Assembly

As shown in FIG. 4, the present embodiment includes a supporting core rod 4, which is preferably made of a stainless steel wire and has a diameter range of preferably 0.8 mm-2.5 mm. The supporting core rod 4 is not limited to be made of the stainless steel wire of the present embodiment and may also be made of other rigid metal wires. The diameter of the supporting core rod 4 is not limited to the range of the present embodiment; and the diameter of the supporting core rod may be set according to the width of a slot of a box body.

The supporting core rod 4 is equipped with a clamp. The clamp has a structure as shown in FIG. 2, and includes a connecting part 1 and a clamping part 2 extending from the connecting part 1. The clamping part 2 includes oppositely arranged elastic compressing pieces 21.

Further preferably, an accommodating groove 3 is formed in the connecting part 1; the accommodating groove 3 is a closing-in groove; and the elastic compressing pieces 21 are connected with an open end of the accommodating groove 3. The connecting part 1 can be assembled with the supporting core rod 4 through the accommodating groove 3 in a penetrating and matching manner, so that the supporting core rod 4 is arranged in the accommodating groove 3. When the elastic compressing pieces 21 are pressed relatively, the elastic compressing pieces 21 drive the open end of the accommodating groove 3 to close in, so that a groove wall of the accommodating groove 3 can be tightly held and matched with the supporting core rod 4.

Further preferably, the elastic compressing pieces 21 are arranged into a plate-like structure; and the lengths of the elastic compressing pieces 21 extend along a direction of a center line of the accommodating groove 3. Due to a large operating area, the elastic compressing pieces 21 with the plate-like structure are more convenient to be held and pressed during manual operation, so that the risk of finger pressing pain caused by pressing and holding a buckle with a metal wire structure by fingers for a long time in the prior art does not exist.

Lower halves of the elastic compressing pieces 21 are gradually and obliquely extended relatively outward from bottom to top to form relatively outwardly expanded clamping shoulders 22; and upper halves of the elastic compressing pieces 21 are vertically extended upward from the clamping shoulders 22 in parallel with each other.

Further preferably, an outer peripheral surface of the connecting part 1 is arranged into a circular arc surface; and the accommodating groove 3 is further arranged into an arc-shaped groove. Thus, the connecting part 1 forms a C-shaped tubular structure. An inner cavity of the C-shaped tubular structure is the accommodating groove 3; and a central angle subtended by the arcs at both ends of an opening of the C-shaped tubular structure is 20°-50°. When the supporting core rod 4 is located in the accommodating groove 3, the connecting part 1 of the clamp can be clamped on the supporting core rod 4 and tightly held. When the elastic compressing pieces 21 are clamped into the slot between the inner container and the housing, the supporting core rod 4 is more tightly held by the connecting part 1 through compression of the elastic compressing piece 21, so that the clamp in the present embodiment is stably assembled on the supporting core rod 4.

Certainly, in other embodiments, for better holding the supporting core rod 4 by the accommodating groove 3, the shape of the accommodating groove 3 should be arranged in accordance with the shape of the outer peripheral surface of the supporting core rod 4. Therefore, the shape of the accommodating groove 3 is not limited herein.

In other embodiments, the connecting part 1 may also be arranged into other structures, such as solid cylinders, and the connecting part having such a structure may be connected to the supporting core rod 4 by welding, gluing or other manners, or can also be connected with the supporting core rod through threaded connection with the supporting core rod 4.

In other embodiments, the outer peripheral surface of the connecting part 1 may be arranged into various shapes as required, such as a triangular structure, a square structure and a prismatic structure.

In other embodiments, the supporting core rod 4 may also be equipped with clamps with other structures, such as the clamp described in the embodiment 2 of the clamp. As long as the clamp can be matched and connected with the supporting core rod 4 and realize a clamping function through the elastic compressing pieces, the clamp falls into the scope protected by the present application.

The supporting core rod 4 of the present embodiment can provide a stable mounting position for mounting the clamp. The clamp does not need to be screwed into the interior of the sealing strip for connection and do not directly contact and connect with the sealing strip. Therefore, the thermal insulating layer of the sealing strip is not damaged, and the sealing and thermal insulating effect of the sealing strip is ensured. Meanwhile, the sealing strip is prevented from being scrapped due to problems of mounting misplacement of the sealing strip caused by errors of a mounting position of the clamp.

### Embodiment 1 of a Sealing Strip

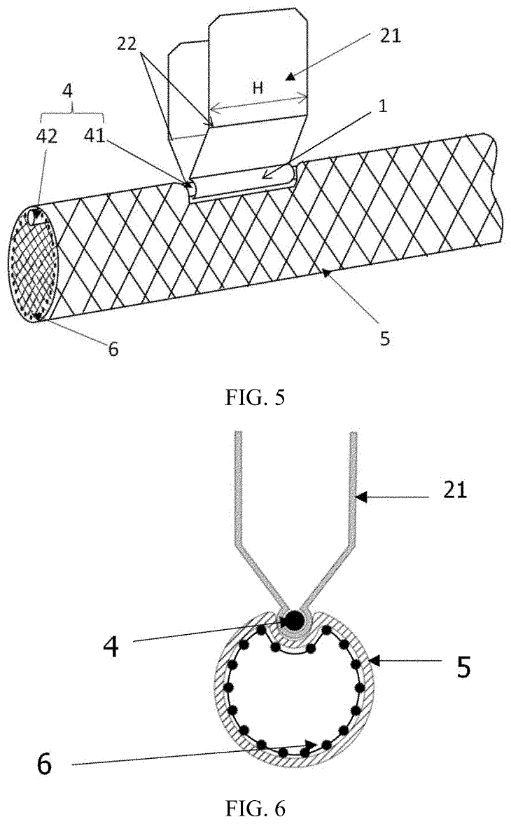

As shown in FIG. 5, the present embodiment includes a strip-shaped thermal insulating layer 5, which adopts a hollow structure formed by crocheting or weaving a plurality of temperature-resistant yarns. The temperature-resistant yarns are preferably made of glass fibers, but can also be made of any other temperature-resistant material, such as high silica and basalt.

The strip-shaped thermal insulating layer 5 of the present embodiment is assembled and connected with a supporting core rod 4; and the supporting core rod 4 is equipped with a clamp.

The present embodiment is further preferably arranged as follows. The supporting core rod 4 penetrates into the hollow interior of the strip-shaped thermal insulating layer 5 and penetrates through an outer peripheral surface of the strip-shaped thermal insulating layer 5 at certain intervals; a part of the supporting core rod 4 located in the hollow interior of the strip-shaped thermal insulating layer 5 is an internal part 42; the internal part 42 is compressed and matched with an inner wall of the strip-shaped thermal insulating layer 5; a part of the supporting core rod 4 penetrating through the outer peripheral surface of the strip-shaped thermal insulating layer 5 is an external part 41; and the clamp is connected to the position of the external part 41 of the supporting core rod 4.

Firstly, the supporting core rod 4 provides certain rigidity for the present embodiment. Once the present embodiment has rigidity, the number of required clamps will be reduced by at least half compared with the number of the clamps required for the sealing strip without rigidity in the prior art; the number of times of stuffing the clamps is greatly reduced under the same manual mounting conditions; the labor costs are reduced; and the working efficiency is improved.

Secondly, the supporting core rod 4 penetrates from the interior to the exterior of the strip-shaped thermal insulating layer 5, and then penetrates into the interior, so that the supporting core rod 4 can be firmly connected with the strip-shaped thermal insulating layer 5 without adopting other fixing modes, thereby saving process cost. Moreover, the supporting core rod 4 provides a firm mounting position for mounting the clamp.

To prevent the supporting core rod 4 from damaging the strip-shaped thermal insulating layer 5 in the process of penetrating into and out of the strip-shaped thermal insulating layer 5, a head part of the supporting core rod 4 can be made into a tip. Once the supporting core rod 4 penetrates through the strip-shaped thermal insulating layer 5, staggered temperature-resistant yarns can be translated and staggered at a place where the supporting core rod 4 passes. Thus, the temperature-resistant yarns will not be damaged or an uneven surface of the strip-shaped thermal insulating layer 5 is not generated, thereby ensuring the sealing and thermal insulating effect of the present embodiment.

Further, an optimal length of the external part 41 of the supporting core rod 4 is greater than 5%6-10% of the length H of each elastic compressing piece 21, thereby preventing the strip-shaped thermal insulating layer 5 from being scratched caused by that the clamp is clamped into the external part 41 of the supporting core rod 4.

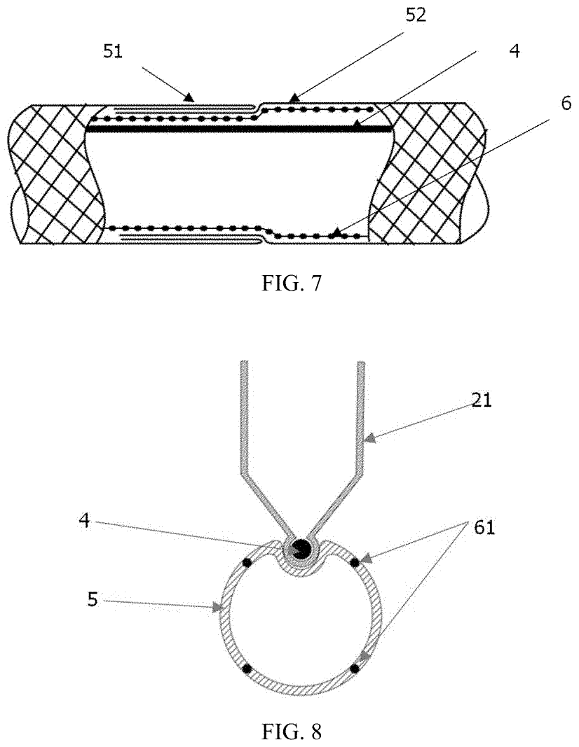

The present embodiment is further preferably arranged as follows. A front end and a tail end of the supporting core rod 4 can be connected by pressing buckle or electric welding, so that the supporting core rod 4 forms a closed annular structure; and the front end and the tail end of the supporting core rod 4 are both located inside the strip-shaped thermal insulating layer 5. As shown in FIG. 7, an end face of one of the front end and the tail end of the strip-shaped thermal insulating layer 5 is folded inward to form a folding end 51, while the other end 52 is inserted into an inner hole of the folding end 51, so that the strip-shaped thermal insulating layer 5 forms the closed annular structure.

The supporting core rod 4 and the strip-shaped thermal insulating layer 5 can be respectively connected into annular structures with corresponding dimensions according to the structures of required mounting positions, thereby facilitating manual mounting operation.

As shown in FIGS. 5 and 6, further preferably, the present embodiment further includes an elastic supporting net 6 attached to the interior of the strip-shaped thermal insulating layer 5; and the elastic supporting net 6 can be made by the same process as the strip-shaped thermal insulating layer 5 and is preferably made of stainless steel wires.

Further preferably in the present embodiment, the clamp of the present embodiment has a structure as shown in FIGS. 2 and 5. The clamp includes a connecting part 1 and a clamping part 2 extending from the connecting part 1; and the clamping part 2 includes oppositely arranged elastic compressing pieces 21.

Since the connecting part 1 and the clamping part 2 of the clamp are integrally extended, a protruding free end does not exist at a joint of the clamping part 2 and the connecting part 1, so that a risk that the hand is stabbed during manual operation does not exist.

The present embodiment is further preferably arranged as follows. An accommodating groove 3 is formed in the connecting part 1; the accommodating groove 3 is a closing-in groove; and the elastic compressing pieces 21 are connected with an open end of the accommodating groove 3. Thus, the connecting part 1 can be connected with the supporting core rod through the accommodating groove 3 in a penetrating and matching manner; and when the elastic compressing pieces 21 are pressed relatively, the elastic compressing pieces 21 drive the open end of the accommodating groove 3 to close in, so that a groove wall of the accommodating groove 3 can be tightly held and matched with the supporting core rod, thereby preventing the clamp from moving on the supporting core rod, and further enabling the present embodiment to have a more stable structure.

Certainly, in other embodiments, the connecting part 1 may also be arranged into other structures, such as solid cylinders, and the connecting part having such a structure may be connected to the supporting core rod by welding, gluing or other manners, or be in threaded connection with the supporting core rod and the like.

The present embodiment is further preferably arranged as follows. The elastic compressing pieces 21 of the clamp of the present embodiment are arranged into a plate-like structure; and the lengths of the elastic compressing pieces 21 extend along a direction of a center line of the accommodating groove 3. Due to a large operating area, the elastic compressing pieces 21 with the plate-like structure are more convenient to be held and pressed during manual operation, so that the risk of finger pressing pain caused by pressing and holding a buckle with a metal wire structure by fingers for a long time in the prior art does not exist.

Lower halves of the elastic compressing pieces 21 of the clamp in the present embodiment are gradually and obliquely extended relatively outward from bottom to top to form relatively outwardly expanded clamping shoulders 22; and upper halves of the elastic compressing pieces 21 are vertically extended upward from the clamping shoulders 22 in parallel with each other, so that a compression range between the two elastic compressing pieces 21 is relatively large, which is more suitable for a situation that the precision of the clamping part is not high.

The present embodiment is further preferably arranged as follows. An outer peripheral surface of the connecting part 1 of the clamp is arranged into a circular arc surface, so that the present embodiment is more smoothly mounted on the supporting core rod.

Certainly, in other embodiments, to facilitate the connection of the connecting part 1 and the supporting core rod, the outer peripheral surface of the connecting part 1 may be arranged into various shapes as required. The shape of the outer peripheral surface of the connecting part 1 is not limited herein.

The present embodiment is further preferably arranged as follows. The accommodating groove 3 is further arranged into an arc-shaped groove, so that the holding area is larger and the holding effect is better.

Certainly, in other embodiments, for better holding the supporting core rod by the accommodating groove 3, the shape of the accommodating groove 3 should be arranged in accordance with the shape of the outer peripheral surface of the supporting core rod. Therefore, the shape of the accommodating groove 3 is not limited herein.

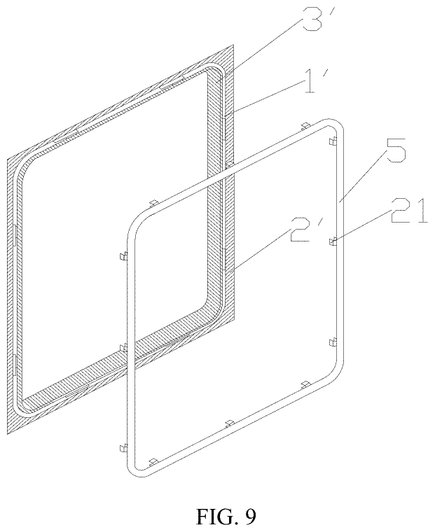

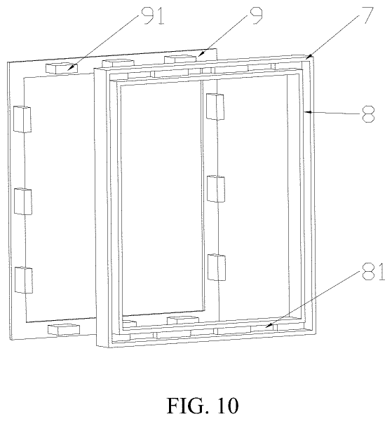

As shown in FIG. 9, for example, the present embodiment is mounted in the slot 1′ between the inner container 3′ and the housing 2′ of the box body. The present embodiment can be assembled in an assembling manner at first. Assembling steps are as follows: firstly, the strip-shaped thermal insulating layer 5 internally attached with the elastic supporting net 6 and having the same length as the slot 1′ is selected; then, the supporting core rod 4 with the same length as the slot 1′ is selected; when the supporting core rod 4 penetrates into a hollow cavity of the strip-shaped thermal insulating layer 5 attached with the elastic supporting net 6 and reaches a preset clamping position of the strip-shaped thermal insulating layer 5, the supporting core rod 4 penetrates through the elastic supporting net 6 and the strip-shaped thermal insulating layer 5 through meshes of the elastic supporting net 6 and weaving gaps of the strip-shaped thermal insulating layer 5, is exposed on the outer peripheral surface of the strip-shaped thermal insulating layer 5, and penetrates into the hollow cavity of the strip-shaped thermal insulating layer 5 attached with the elastic supporting net 6 again after exposure for a certain length; and the internal part 42 located in the hollow cavity of the strip-shaped thermal insulating layer 5 is compressed and matched with an inner wall of the elastic supporting net 6, and is further indirectly compressed on the inner wall of the strip-shaped thermal insulating layer 5. The supporting core rod 4 continues to extend in the hollow cavity of the strip-shaped thermal insulating layer 5 attached with the elastic supporting net 6, penetrates through the elastic supporting net 6 and the strip-shaped thermal insulating layer 5 again when reaching the preset clamping position of the next strip-shaped thermal insulating layer 5, is exposed on the outer peripheral surface of the strip-shaped thermal insulating layer 5, and penetrates into the hollow cavity of the strip-shaped thermal insulating layer 5 attached with the elastic supporting net 6 again after exposure for a certain length; and the supporting core rod 4 is sequentially connected with the strip-shaped thermal insulating layers 5 in a penetrating manner according to the above connecting steps. The exposed part of the supporting core rod 4 avoids the welding position of the slot according to the preset clamping position. After completing the connection of the supporting core rod 4 and the strip-shaped thermal insulating layer 5, the clamp is taken and mounted into the external part 41 of the supporting core rod 4 exposed on the outer peripheral surface of the strip-shaped thermal insulating layer 5. The mounting method comprises the following steps: one elastic compressing piece 21 of the clamp penetrates into the gap between the supporting core rod 4 and the outer peripheral surface of the strip-shaped thermal insulating layer 5, while the other elastic compressing piece 21 is located above the supporting core rod 4, and then the clamp is moved so that the accommodating groove of the connecting part 1 clamps and holds the external part 41 of the supporting core rod; and the clamp is rotated by an angle of 90° to complete the mounting of the clamp. Finally, the front end and the tail end of the supporting core rod 4 are connected; and the front end and the tail end of the strip-shaped thermal insulating layer 5 are connected. The present embodiment has rigidity and can be connected into a closed annular structure with the same dimension and shape as the slot 1′. During mounting, the present embodiment only needs to be aligned with the slot 1′; the elastic pressing pieces 21 are pressed, so that the elastic pressing pieces 21 are clamped into the slot; and the clamps are pushed and compressed into the slot 1′. The mounting is completed when the clamping shoulders 22 of the elastic pressing pieces 21 are clamped to the end faces of the folding edges of the inner container 3′ and the housing 2′. When the present embodiment is clamped into the slot 1′ between the inner container 3′ and the housing 2′ of the box body through the elastic pressing pieces 21 and when a door of the box body is closed, the strip-shaped thermal insulating layer 5 can be compressed between the door of the box body and the box body by the elastic supporting net 6, thereby isolating the inner container of the box body from the outside. The present embodiment solves the problem of complicated mounting operation in the prior art and also has the conditions of automatic assembly.

Automatic mounting may be adopted for the mounting of the present embodiment mentioned in the present embodiment; and examples and mounting processes of a mounting fixture for automatic mounting are as follows.

As shown in FIG. 10 of the structural schematic diagram of an example of the mounting fixture, the mounting fixture includes a mounting seat 7. A mounting groove 8 matched with an appearance structure of the present embodiment is arranged on a front side of the mounting seat 7; and a pushing-in hole 81 penetrating through the mounting seat 7 is formed in a bottom wall of the mounting groove 8. The mounting fixture further includes a pushing frame 9; and a bulge 91 is arranged on the pushing frame 9.

When automatic mounting is adopted, the present embodiment is mounted in the mounting groove 8 in the mounting seat 7 at first; the clamp in the present embodiment is aligned at the position of the pushing-in hole 81; the mounting seat 7 is aligned with the slot; the end of the clamp is exposed to an upper surface of the mounting seat 7; the end of the clamp is slightly stuffed into the slot; the pushing frame 9 is moved from a rear side of the mounting seat 7 to the mounting seat 7 by using a manipulator, the bulge 91 on the pushing frame 9 is inserted into the pushing-in hole 81 in the mounting seat 7; the pushing frame 9 is continuously moved, so that the bulge 91 ejects and pushes the clamp in the present embodiment and pushes the clamp into the slot; and the mounting seat 7 and the pushing frame 9 are moved to complete mounting.

In the process of mounting the present embodiment, the end of the clamp is slightly stuffed into the slot. In such a process, a method that the elastic compressing pieces of the clamp are manually pressed can be adopted, so that the mounting of the present embodiment is semi-automatic mounting. Certainly, the elastic compressing pieces of the clamp can also be pressed by using the manipulator or a compression device, so that the mounting of the present embodiment is full-automatic mounting; and the full-automatic mounting can greatly reduce the labor cost, improve the mounting efficiency, and improve the mounting accuracy and the consistency of batch mounting.

The above compression device may adopt a structure that the compression device includes a driving assembly, an external pressing piece and an internal pressing piece. The external pressing piece is composed of an upper external pressing plate, a lower external pressing plate, a left external pressing plate and a right external pressing plate; the four external pressing plates are located outside the outer peripheral surface of the mounting seat 7; pressing fingers are arranged on the four external pressing plates in a manner of protruding inwards; the internal pressing piece is composed of an upper internal pressing plate, a lower internal pressing plate, a left internal pressing plate and a right internal pressing plate; the four internal pressing plates are located in a hollow region formed in the middle of the mounting seat 7; and pressing fingers are arranged on the four internal pressing plates in a manner of protruding outwards. The driving assembly includes a disk and a motor connected with the disk. The four external pressing plates and the four internal pressing plates are eccentrically arranged on the disk, so that the four internal pressing pieces are expanded and moved outwards and the four external pressing pieces are contracted and moved inwards when the disk is rotated.

During use, after the present embodiment is mounted on the mounting seat, the compression device is started, so that the motor drives the disk to rotate. The disk drives the four internal pressing plates to expand outwards; the pressing fingers on the four internal pressing plates press the elastic compressing pieces inside the clamp; meanwhile, the disk drives the four external pressing plates to contract inwards; and the pressing fingers on the four external pressing plates press the elastic compressing pieces outside the clamp, so that the two elastic compressing pieces of the clamp are contracted relatively. The mounting seat and the compression device are moved toward the slot together. When the end of the clamp is slightly inserted into the slot, the motor drives the disk to rotate reversely; and the internal pressing plates are contracted and returned inwards, and the external pressing plates are expanded and returned outwards at this time, which does not affect the subsequent mounting of the present embodiment.

Certainly, the structure of the compression device is not limited to such a structure; and the compression devices with other structures can also be adopted, as long as the elastic compressing pieces of the clamp can be pressed, and the two elastic compressing pieces can be relatively contracted. The present embodiment can realize automatic mounting, has high mounting efficiency and accurate mounting position, and greatly reduces the labor cost.

The above mounting fixture is only one embodiment. In other embodiments, the above mounting fixture can also use the manipulator to directly move and push the present embodiment into the slot according to the position of the clamp in the present embodiment.

The supporting core rod 4 and the clamp of the present embodiment are assembled outside the strip-shaped thermal insulating layer 5, thereby ensuring that the strip-shaped thermal insulating layer 5 of the present embodiment will not be damaged and will not affect the sealing effect.

The present embodiment is mounted in the slot 1′ between the inner container 3′ and the housing 2′ of the box body. The center line of the present embodiment and the center line of the slot 1′ are located on the same plane, thereby completely solving the problem of positional deviation between the center line of the sealing strip and the slot 1′. Moreover, once the clamp is stuffed into the slot, the supporting core rod 4 can be pressed at the same time, thereby completely sealing the slot 1′.

Certainly, in other embodiments, the strip-shaped thermal insulating layer 5 can be produced by other processes and can also be of a solid structure. If the strip-shaped thermal insulating layer 5 is of the solid structure, the supporting core rod 4 can be directly and fixedly arranged on the outer peripheral surface of the strip-shaped thermal insulating layer 5. When the supporting core rod 4 is also connected with the strip-shaped thermal insulating layer 5 in a penetrating manner, since the strip-shaped thermal insulating layer 5 has elasticity, even if the supporting core rod 4 penetrates out or penetrates into the strip-shaped thermal insulating layer 5, the outer peripheral surface of intersection of the supporting core rod 4 and the strip-shaped thermal insulating layer 5 is matched with the strip-shaped thermal insulating layer 5 in a sealing manner, so that the sealing and thermal insulating effect will not be affected. The production process and the structural shape of the strip-shaped thermal insulating layer 5 are not limited herein.

In other embodiments, the clamp in the above embodiment can also adopt the structure of the embodiment of the clamp described in the embodiment 2 of the clamp. Thus, when the present embodiment is mounted in the slot, the end of the clamp in the present embodiment can be stuffed into the slot in a natural state without pressing the elastic compressing pieces 21. Moreover, when the automatic mounting is adopted for the present embodiment and the end of the clamp is stuffed into the slot, the mounting seat 7 can be directly pushed to approach the slot so that the end of the clamp can be stuffed into the slot. By adopting the clamp in the present embodiment, the end of the clamp can be stuffed into the slot without manually pressing the clamp or pressing the elastic compressing pieces 21 with other compression devices or an individual machine, thereby saving the process steps, reducing the process cost and improving the mounting efficiency.

In other embodiments, the clamp in the above embodiment can also be the clamp in the prior art; and as long as the clamp can be mounted on the supporting core rod and the clamp in the present embodiment can be clamped to the required mounting position, the clamp also falls into the scope protected by the present application.

### Embodiment 2 of the Sealing Strip

The present embodiment is different from the embodiment 1 of the sealing strip in that the elastic supporting net 6 is embedded inside the solid structure of the strip-shaped thermal insulating layer 5. The structure that the stainless steel wires 61 for making the elastic supporting net 6 are added while weaving the strip-shaped thermal insulating layer 5 is adopted, so that the stainless steel wires 61 are woven together with weaving materials of the strip-shaped thermal insulating layer 5; and the number and the diameter of the stainless steel wires 61 depend on the required elasticity and are not limited herein.

The elastic supporting net 6 and the strip-shaped thermal insulating layer 5 form an integrated structure, which increases the stability of an overall structure of the present embodiment. Meanwhile, the present embodiment has simpler structure, more convenient operation, and more convenient mounting of the supporting core rod and improves the working efficiency of assembly.

The above only describes the embodiments of the present invention and is not intended to limit the patent scope of the present invention. Any equivalent structural transformation made by using contents of the specification and the accompanying drawings of the present invention, or directly or indirectly applied in other related technical fields, shall be included in the patent protection scope of the present invention.

We claim:

1. A sealing strip, comprising a strip-shaped thermal insulating layer, wherein the strip-shaped thermal insulating layer is matched and connected with a supporting core rod; and clamps are assembled on the supporting core rod.

2. The sealing strip according to claim 1, wherein the strip-shaped thermal insulating layer is of a hollow structure; the supporting core rod comprises an internal part located inside the hollow interior of the strip-shaped thermal insulating layer and external parts penetrating through an outer peripheral surface of the strip-shaped thermal insulating layer at intervals; and the clamps are connected to the external parts of the supporting core rod.

3. The sealing strip according to claim 2, wherein a front end and a tail end of the supporting core rod are connected with each other, so that the supporting core rod forms a closed annular structure; and the front end and the tail end of the strip-shaped thermal insulating layer are connected with each other, so that the strip-shaped thermal insulating layer forms an annular structure corresponding to the annular structure of the supporting core rod.

4. The sealing strip according to claim 3, wherein the sealing strip further comprises an elastic supporting net which is attached to an inner wall of a hollow inner cavity of the strip-shaped thermal insulating layer, or the elastic supporting net is embedded in a solid structure of the strip-shaped thermal insulating layer.

5. The sealing strip according to claim 1, wherein each clamp comprises a connecting part and a clamping part extending from the connecting part; each clamping part comprises oppositely arranged elastic compressing pieces; and the connecting parts are matched and connected with the supporting core rod.

6. The sealing strip according to claim 5, wherein an accommodating groove is formed in each connecting part; the accommodating groove is a closing-in groove; the elastic compressing pieces are connected with an open end of the accommodating groove; and the supporting core rod is arranged in the accommodating groove.

7. The sealing strip according to claim 6, wherein the elastic compressing pieces are of a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

8. The sealing strip according to any one of claim 5, wherein the outer peripheral surface of the connecting part is a circular arc surface.

9. The sealing strip according to claim 8, wherein the accommodating groove is an arc-shaped groove.

10. A buckle assembly, comprising a supporting core rod assembled on a sealing member and a clamp assembled on the supporting core rod; the clamp comprises a connecting part and a clamping part extending from the connecting part; the connecting part is matched and connected with the supporting core rod; and the clamping part comprises oppositely arranged elastic compressing pieces.

11. The buckle assembly according to claim 10, wherein an accommodating groove is formed in the connecting part; the accommodating groove is a closing-in groove; the elastic compressing pieces are connected with an open end of the accommodating groove; and the supporting core rod is arranged in the accommodating groove.

12. The buckle assembly according to claim 11, wherein the elastic compressing pieces are of a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

13. The buckle assembly according to any one of claim 10, wherein the outer peripheral surface of the connecting part is a circular arc surface.

14. A clamp, comprising a connecting part and a clamping part extending from the connecting part; the clamping part comprises oppositely arranged elastic compressing pieces; an accommodating groove is formed in the connecting part; the accommodating groove is a closing-in groove; the elastic compressing pieces are connected with an open end of the accommodating groove; the elastic compressing pieces are of a plate-like structure; the lengths of the elastic compressing pieces extend along a direction of the center line of the accommodating groove; lower halves of the elastic compressing pieces are gradually and obliquely extended relatively outward from bottom to top to form relatively outwardly expanded clamping shoulders; upper halves of the elastic compressing pieces are vertically extended upward from the clamping shoulders in parallel with each other, or the upper halves of the elastic compressing pieces are gradually and obliquely closed relatively inwards and upwards from the clamping shoulders.

15. The clamp according to claim 14, wherein the outer peripheral surface of the connecting part is a circular arc surface.

16. The clamp according to claim 15, wherein the accommodating groove is an arc-shaped groove.
